(19) United States
(12) Patent Application Publication
(10) Pub. No.: US 2026/0093934 A1
(43) Pub. Date: Apr. 2, 2026

(54) DATA GENERATION

(71) Applicants: Beijing Zitiao Network Technology Co., Ltd., Beijing (CN); Lemon Inc., Grand Cayman (KY)

(72) Inventors: Ying Zhou, Beijing (CN); Xinyao Wang, Los Angeles, CA (US); Yulei Niu, Los Angeles, CA (US); Yaojie Shen, Beijing (CN); Lexin Tang, Los Angeles, CA (US); Fan Chen, Los Angeles, CA (US); Longyin Wen, Los Angeles, CA (US)

(21) Appl. No.: 19/342,981

(22) Filed: Sep. 29, 2025

(30) Foreign Application Priority Data
Sep. 29, 2024 (CN) 202411379253.4

(51) Int. Cl. G06F 40/40; G06F 40/284; G06N 3/0455

(52) U.S. Cl. CPC G06F 40/40; G06F 40/284; G06N 3/0455

(57) ABSTRACT

Embodiments of the disclosure relate to a method, an apparatus, a device and a computer readable storage medium for generating data. The method proposed herein includes: obtaining a first feature representation by sampling from a target feature space, the target feature space being determined by processing a set of training samples with an encoding unit; processing the first feature representation with a diffusion unit to determine a second feature representation; and providing a second feature representation to a pre-trained language model to generate a target data sample.

### CROSS-REFERENCE

The present application claims priority to Chinese Patent Application No. 202411379253.4, filed on Sep. 29, 2024, and entitled “METHOD, APPARATUS, DEVICE, AND STORAGE MEDIUM FOR GENERATING DATA”, which is incorporated herein by reference in its entirety.

### FIELD

Example embodiments of the present disclosure generally relate to the field of computers, and more particularly, to data generation.

### BACKGROUND

With the development of computer technologies, generative models have been widely applied to the generation of various modal content. For example, language models can synthesize the desired data based on prompts entered by the user. However, generating accurate and high-quality data through prompts remains extremely challenging due to the inherent uncertainty of prompt engineering and the limitations of the model on target data distribution and structural understanding.

### SUMMARY

In a first aspect of the present disclosure, a method of generating data is provided. The method comprises: obtaining a first feature representation by sampling from a target feature space, the target feature space being determined by processing a set of training samples with an encoding unit; processing the first feature representation with a diffusion unit to determine a second feature representation; and providing the second feature representation to a pre-trained language model to generate a target data sample.

In a second aspect of the present disclosure, an apparatus for generating data is provided. The apparatus comprises: a sampling module configured to obtain a first feature representation by sampling from a target feature space, the target feature space being determined by processing a set of training samples with an encoding unit; a processing module configured to process the first feature representation with a diffusion unit to determine a second feature representation; and a generation module configured to provide a second feature representation to the pre-trained language model to generate a target data sample.

In a third aspect of the present disclosure, an electronic device is provided. The apparatus comprises at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by a processor to implement the method of the first aspect.

It should be understood that what is described in this Summary is not intended to limit the key features or essential features of the embodiments of the present disclosure, nor is it intended to limit the scope of the present disclosure. Other features of the present disclosure will become readily understood from the following description.

### BRIEF DESCRIPTION OF DRAWINGS

The above-mentioned and other features, advantages, and aspects of various embodiments of the present disclosure will become more apparent from the following detailed description taken in conjunction with the accompanying drawings. In the drawings, the same or similar reference numerals denote the same or similar elements, wherein:

FIG. 1 illustrates a schematic diagram of an example environment in which embodiments according to the present disclosure may be implemented;

FIG. 2 illustrates a flowchart of an example process of generating data according to some embodiments of the present disclosure;

FIG. 3 illustrates a schematic block diagram of an example data synthesis system according to some embodiments of the present disclosure;

FIG. 4 illustrates a schematic structural block diagram of an example apparatus for generating data according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the heading of any section/subsection provided in this article is not limiting. Various embodiments are described throughout herein, and any type of embodiments can be included in any section/subsection. Furthermore, the embodiments described in any section/subsection may be combined in any way with any other embodiments in the same section/subsection and/or any other embodiment described in different sections/subsections.

In the description of the embodiments of the present disclosure, the terms “including” and similar expressions should be understood as an open-ended inclusion, this is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” etc. 1 refer to different or the same object. Other explicit and implicit definitions may also be included below.

Embodiments of the present disclosure may relate to data of a user, the obtaining and/or use of data, etc. These aspects all comply with corresponding laws, regulations and relevant regulations. In the embodiments of the present disclosure, collection, obtaining, processing, processing, forwarding, use, etc. of all data, are performed with the user's knowledge and confirmation. Accordingly, when implementing each embodiments of the present disclosure, users should be informed of the type, scope of use, usage scenarios, etc. that may be involved in the data or information and obtain their authorization through appropriate means in accordance with relevant laws and regulations. The specific notification and/or authorization methods may vary according to actual situations and application scenarios, and the scope of the present disclosure is not limited in this respect.

In the solutions in the present specification and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

As mentioned above, generating accurate and high-quality data through prompts remains extremely challenging due to the inherent uncertainty of prompt engineering and the limitations of the model on target data distribution and structural understanding.

Embodiments of the present disclosure provide a solution for generating data. According to the solution, the first feature representation may be obtained by sampling from a target feature space, and the target feature space is determined by processing a set of training samples with an encoding unit. Further, the first feature representation may be processed with a diffusion unit to determine a second feature representation. Accordingly, the second feature representation may be provided to the pre-trained language model to generate the target data sample.

Through feature space modeling and denoising diffusion processes, embodiments of the present disclosure can preserve core features of data and ensure diversity and realism of the synthesized data samples. Thus, embodiments of the present disclosure are capable of generating data samples of high quality and highly similar to real data.

Various example implementations of the solution are described in further detail below with reference to the accompanying drawings.

### Example Environment

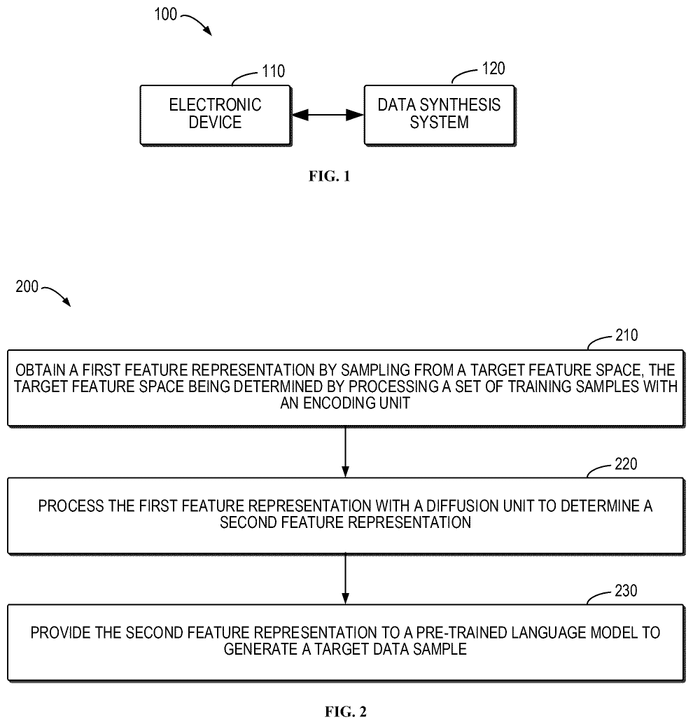

FIG. 1 illustrates a schematic diagram of an example environment 100 in which embodiments of the present disclosure can be implemented. As shown in FIG. 1, the example environment 100 may include an electronic device 110.

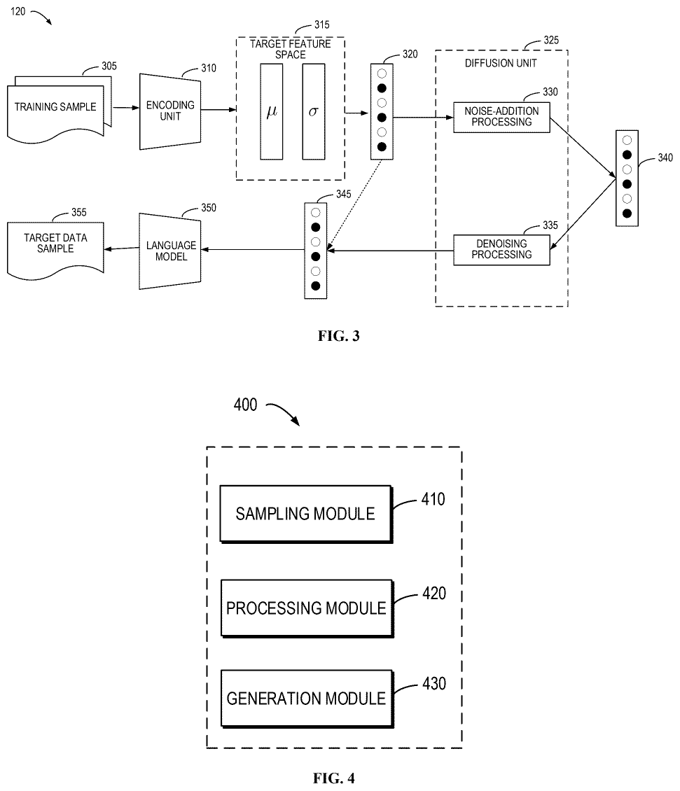

In this example environment 100, the electronic device 110 may deploy the data synthesis system 120 to generate data samples by sampling the feature representation from the feature space determined by training. The specific structure and processing process of the data synthesis system 120 will be described in detail below with reference to FIGS. 2 and 3.

The electronic device 110 may be any type of a mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a Personal Communication System (PCS) device, a personal navigation device, a Personal Digital Assistant (PDA), an audio/video player, a digital camera/camcorder, a positioning device, a television receiver, a radio broadcast receiver, an electronic book device, a gaming device, or any combination of the foregoing, including accessories and peripherals of these devices or any combination thereof. In some embodiments, the electronic device 110 can also support any type of interface for a user (such as a “wearable” circuit, etc.).

The electronic device 110 may also be an independent physical server, or may be a server cluster or a distributed system consisted of a plurality of physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The electronic device 110 may include, for example, a computing system/server, such as a mainframe, an edge computing node, a computing device in a cloud environment, etc.

It should be understood that the structures and functions of the various elements in the environment 100 are described for illustrative purposes only and do not imply any limitation to the scope of the present disclosure.

Some example embodiments of the present disclosure will continue to be described below with reference to the accompanying drawings.

### Example Processes

FIG. 2 illustrates a flowchart of an example process 200 of generating data according to some embodiments of the present disclosure. Process 200 may be implemented at electronic device 110. The process 200 is described below with reference to FIG. 1.

As shown, at block 210, the electronic device 110 obtains a first feature representation by sampling from a target feature space, the target feature space is determined by processing a set of training samples with an encoding unit.

A specific process of generating data will be described below with reference to FIG. 3. FIG. 3 illustrates a schematic block diagram of an example data synthesis system 120 according to some embodiments of the present disclosure. As shown in FIG. 3, the data synthesis system 120 may comprise an encoding unit 310, a pre-trained language model 350, and a diffusion unit 325.

In some embodiments, the encoding unit 310 and the pre-trained language model 350 may constitute a Variational Autoencoder (VAE). Further, the data synthesis system 120 may train the VAE with training samples. During training process of the VAE, parameters of the language model 350 may remain fixed, and parameters of the encoding unit 310 may be adjusted based on the VAE loss.

In some embodiments, the encoding unit 310 may be implemented with a pre-trained language model, and the scale of the language model used as the encoding unit 310 may be smaller than the scale of the language model 350 used as the decoding unit in the VAE. As an example, the encoding unit 310 may be implemented, for example, with a language model such as BERT (Bidirectional Encoder Representation from Transformers).

As shown in the figure, during the training process of the VAE, the data synthesis system 120 may determine a first training feature representation of the training sample with the encoding unit 310 to be trained. Further, the data synthesis system 120 may process the first training feature representation with the pre-trained language model 350 to determine a first training loss of the variational autoencoder (VAE) comprising the encoding unit and the pre-trained language model.

Furthermore, the data synthesis system 120 may fix parameters of the language model 350 and adjust parameters of the encoding unit 310 based on the first training loss. As an example, the first training loss of the VAE may comprise a reconstruction loss and a KL loss:

$${ELBO}_{β} = {L}_{rec} - β {L}_{kl} \qquad ( 1 )$$

$${L}_{rec} = {𝔼}_{q ϕ ( z \vert x )} ( log {p}_{θ} ( x \vert z ) ) \qquad ( 2 )$$

$${L}_{kl} = {D}_{KL} ( {q}_{ϕ} ( z \vert x ) ‖ p ( z ) ) \qquad ( 3 )$$

Formula (1) represents a training target of the VAE, that is, an Evidence Lower Bound (ELBO), which may be determined based on a reconstruction loss L_{rec} and a KL loss Lₖₗ, where β is a weight coefficient used to balance reconstruction quality and smoothness of the feature space.

Equation (2) represents the calculation process of reconstruction loss, where q_{φ}(z|x) represents the posterior distribution of the feature vector z generated when the encoding unit given the input x, p_{θ}(x|z) represents the probability that the decoding unit (i.e., the language model) reconstructs the input x given the feature vector z, and [symbol] represents the desired operator to represent the expected value of the reconstruction probability.

Equation (3) represents the calculation process of KL loss, where D_{KL} represents the Kullback-Leibler divergence calculation; for q_{φ}(z|x), please refer to the explanation of formula (2); and p(z) represents a priori distribution of the feature vector z, for example, a standard normal distribution.

Therefore, the data synthesis system 120 may train the VAE comprising the encoding unit 310 and the language model 350 with the training samples, and obtain the trained encoding unit 310. Further, the data synthesis system 120 may process a set of training samples 305 with the trained encoding unit 310 to determine a target feature space 315 corresponding to the set of training samples 305.

In some embodiments, as mentioned above, the encoding unit 310 may be implemented with a language model. Correspondingly, the encoding unit 310 may, for example, process the training text content corresponding to the set of training samples 305 to determine the target feature space. As an example, training samples 305 may comprise table samples and may be converted to corresponding text content to be input into encoding unit 310.

Further, as shown in FIG. 3, the data synthesis system 120 may sample the first feature representation 320 from the target feature space 315.

At block 220, the electronic device 110 processes the first feature representation with a diffusion unit to determine a second feature representation.

As shown in FIG. 3, the diffusion unit 325 may comprise a noise addition module for performing the noise addition process 330 and a denoising module for performing the denoising process 335. Specifically, the diffusion unit 325 may perform the noise addition processing 330 on the first feature representation 320 obtained by sampling, with the noise addition module to generate the noise addition feature representation 340. Further, the diffusion unit 325 may perform the denoising processing 335 on the noise addition feature representation 340 with the denoising module to determine the second feature representation 345.

As an example, the noise addition process 330 may be expressed as a formula (4), and the denoising process 335 may be expressed as a formula (5):

$${z}_{t} = {z}_{0} + σ ( t ) ϵ , ϵ ∈ 𝒩 ( 0 , I ) \qquad ( 4 )$$

$${dz}_{t} = - \dot{σ} ( t ) σ ( t ) {∇}_{{z}_{t}} log p ( {z}_{t} ) dt + \sqrt{2 \dot{σ} ( t ) σ ( t )} d {ω}_{t} \qquad ( 5 )$$

where in formula (4), z₀ represents an initial first feature representation, t represents a time step of the diffusion forward process, σ(t) represents a time-dependent noise scale function, which determines an amount of noise added at time step t, and ϵ∈ [symbol] (0, I) represents a noise item sampled from a standard normal distribution. In formula (5), \dot{σ}(t) represents the derivative of the noise scale function with respect to time, and ∇_{z}_{ₜ} log p(zₜ) represents the gradient of the log-probability density function with respect to the hidden variable zₜ.

In some embodiments, the training of the diffusion unit 325 is performed after training of the VAE is completed. Specifically, the data synthesis system 120 may sample to determine the second training feature representation from the training feature space, and the training feature space is determined with the trained encoding unit. Further, the data synthesis system 120 may process the second training feature representation with the diffusion unit 325 to determine a second training loss associated with the diffusion unit 325.

As an example, the second training loss may be expressed as formula (6):

$$ℒ = {𝔼}_{t \sim p ( t ) , {z}_{0} \sim p ( {z}_{0} ) . ϵ \sim 𝒩 ( 0 , I )} {‖ {ϵ}_{θ} ( {z}_{t} , t ) - ϵ ‖}^{2} \qquad ( 6 )$$

where [symbol] represents a desired operator to denote a desired value under a given distribution, t˜p(t) represents a time point sampled from a time distribution p(t), z₀˜p(z₀) represents an initial hidden feature sampled from an initial feature distribution, ϵ∈ [symbol] (0, I) represents a noise term sampled from a standard normal distribution, ϵ_{θ}(zₜ, t) represents a network that predicts noise given a hidden feature zₜ, and a time step t, with parameters θ.

In addition, the data synthesis system 120 may adjust parameters of the diffusion unit 325 based on the second training loss.

At block 230, the electronic device 110 provides the second feature representation to the pre-trained language model to generate the target data sample.

With continued reference to FIG. 3, the electronic device 110 may provide the second feature representation 345 to the language model 350 to generate the target data sample 355.

In some embodiments, the second feature representation 345 may be injected into the language model 350 in an appropriate mode for controlling the processing process of the language model 350. Specifically, the data synthesis system 120 may map the second feature representation to a target token embedding, e.g., Hₗₐₜₑₙₜ. Further, the data synthesis system 120 may inject the target token embedding Hₗₐₜₑₙₜ into the pre-trained language model to generate the target data sample.

In some embodiments, the data synthesis system 120 may inject the target token embedding as a soft prompt token of a language model through a prefix injection mode. Specifically, the soft cue token may be added before a preset marker token (e.g., BOS token) of the language model.

In this injection mode, the second feature representation 345 is mapped and converted into a set of soft prompt marker embedding Hₗₐₜₑₙₜ by a multi-layer perceptron (MLP) of upper-layer. Hₗₐₜₑₙₜ may be spliced as a guide vector before the start tag token (BOS token) of the language model to help the language model better understand the generation target in the decoding process.

In some embodiments, the data synthesis system 120 may inject the target token embedding into the key-value cache of the language model through a cache injection (also referred to as a memory injection) mode.

As an example, the data synthesis system may inject Hₗₐₜₑₙₜ as past key-value (KV) memory into each layer of the language model. This mode utilizes the key value caching technology used in decoding of the language model, by concatenating the mapped Hₗₐₜₑₙₜ with the KV cache to inject the memory information into the multiple layers.

In some embodiments, the data synthesis system 120 may inject the target token embedding into the token embedding space of the language model by embedding injection mode to combine with the original token embedding of the language model.

As an example, the second feature representation 345 may be mapped directly to the token embedding space to combine with the original token embedding H_{emb} to form a new embedding H_{emb}+Hₗₐₜₑₙₜ. This mode may be implemented information injection of the second feature representation by modifying the embedding layer of the language model directly.

In some embodiments, the language model 350 may be configured to output the target text content based on the second feature representation 345 for generating the target data sample 355 corresponding to the target text content. Taking the target data sample as a chart sample as an example, the target text content generated by the language model 350 may be further converted to generate a corresponding chart sample.

In some embodiments, training samples 305 and/or generated target data samples 355 may comprise any appropriate type of data sample, examples of which may include, but are not limited to: a text sample, a code sample, a chart sample, a tool sample, etc.

Therefore, through the feature space modeling and denoising diffusion process, the embodiments of the present disclosure can preserve the core features of the data and ensure the diversity and realism of the synthesized data samples. Thus, embodiments of the present disclosure are capable of generating data samples of high quality and highly similar to real data.

### Example Apparatus and Device

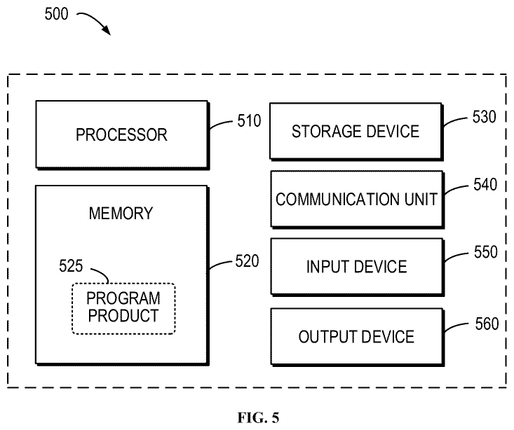

Embodiments of the present disclosure also provide a corresponding apparatus for implementing the above method or process. FIG. 4 illustrates a schematic structural block diagram of an example apparatus 400 for generating data according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes a sampling module 410 configured to obtain a first feature representation by sampling from a target feature space, the target feature space being determined by processing a set of training samples with an encoding unit; a processing module 420 configured to process the first feature representation with a diffusion unit to determine a second feature representation; and a generation module 430 configured to provide a second feature representation to a pre-trained language model to generate a target data sample.

In some embodiments, the encoding unit is trained based on a process comprising: determining a first training feature representation of the training sample with an encoding unit to be trained; processing the first training feature representation with the pre-trained language model, to determine a first training loss of the variational autoencoder (VAE) comprising the encoding unit and the pre-trained language model; and adjusting a parameter of the encoding unit based on the first training loss.

In some embodiments, the processing module 420 is configured to: process the first feature representation with a noise addition module of the diffusion unit to generate a noise addition feature representation; and process the noise addition feature representation with a denoising module of the diffusion unit to generate a second feature representation.

In some embodiments, the diffusion unit is trained based on a process comprising: determining, by sampling from the training feature space, a second training feature representation, the training feature space being determined with the trained encoding unit; processing the second training feature representation with the diffusion unit to determine a second training loss associated with the diffusion unit; and adjusting a parameter of the diffusion unit based on the second training loss.

In some embodiments, the generation module 430 is further configured to: map the second feature representation to a target token embedding; and inject the target token embedding into the pre-trained language model to generate the target data sample.

In some embodiments, the generating module 430 is further configured to: inject the target token as a soft prompt token of the language model to be added before a preset marker token of the language model; inject the target token embedding into a key-value cache of the language model; inject the target token embedding into a token embedding space of the language model to be combined with an original token embedding of the language model.

In some embodiments, the target feature space is determined by processing the training text content corresponding to the set of training samples with the encoding unit.

In some embodiments, the language model is configured to output the target text content based on the second feature representation for generating the target data sample corresponding to the target text content.

In some embodiments, the target data sample comprises at least one of the following: a text sample, a code sample, a chart sample, or a tool sample.

FIG. 5 illustrates a block diagram of an electronic device 500 in which one or more embodiments of the present disclosure may be implemented. It should be understood that the electronic device 500 illustrated in FIG. 5 is merely an example and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. Storage device 530 may be a removable or non-removable medium and may include a machine-readable medium, such as a flash drive, a magnetic disk, or any other medium, which may be used to store information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communications with another electronic device over a communication medium. Additionally, the functionality of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, create means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/actions specified in one or more blocks of the flowchart and/or block diagram(s).

The computer-readable program instructions may be loaded onto a computer, other programmable data processing apparatus, or other apparatus, causing a series of operational steps to be performed on a computer, other programmable data processing apparatus, or other apparatus to produce a computer-implemented process such that the instructions, when executed on a computer, other programmable data processing apparatus, or other devices implement the functions/acts specified in one or more blocks of the flowchart and/or block diagrams.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions marked in the blocks may also occur in a different order than marked in the drawings. For example, two consecutive blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or actions, or may be implemented using a combination of dedicated hardware and computer instructions.

Various implementations of the present disclosure have been described above, the foregoing description is an example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable those skilled in the art to understand the various implementations disclosed herein.

1. A method of generating data, comprising:
obtaining a first feature representation by sampling from a target feature space, the target feature space being determined by processing a set of training samples with an encoding unit;
processing the first feature representation with a diffusion unit to determine a second feature representation; and
providing the second feature representation to a pre-trained language model to generate a target data sample.

2. The method of claim 1, wherein the encoding unit is trained based on a process comprising:
determining a first training feature representation of a training sample with an encoding unit to be trained;
processing the first training feature representation with the pre-trained language model, to determine a first training loss of a variational autoencoder (VAE) comprising the encoding unit and the pre-trained language model; and
adjusting a parameter of the encoding unit based on the first training loss.

3. The method of claim 1, wherein processing the first feature representation using the diffusion unit to determine the second feature representation comprises:
processing the first feature representation with a noise addition module of the diffusion unit to generate a noise addition feature representation; and
processing the noise addition feature representation with a denoising module of the diffusion unit to generate the second feature representation.

4. The method of claim 1, wherein the diffusion unit is trained based on a process comprising:
determining a second training feature representation by sampling from a training feature space, the training feature space being determined with the trained encoding unit;
processing the second training feature representation with the diffusion unit to determine a second training loss associated with the diffusion unit; and
adjusting a parameter of the diffusion unit based on the second training loss.

5. The method of claim 1, wherein providing the second feature representation to the pre-trained language model to generate the target data sample comprises:
mapping the second feature representation to a target token embedding; and
injecting the target token embedding into the pre-trained language model to generate the target data sample.

6. The method of claim 5, wherein injecting the set of token embeddings to the pre-trained language model comprises one of the following:
injecting the target token embedding as a soft prompt token of the language model to be added before a preset marker token of the language model;
injecting the target token embedding into a key-value cache of the language model; or
injecting the target token embedding into a token embedding space of the language model to be combined with an original token embedding of the language model.

7. The method of claim 1, wherein the target feature space is determined by processing training text content corresponding to the set of training samples with the encoding unit.

8. The method of claim 7, wherein the language model is configured to output target text content based on the second feature representation for generating the target data sample corresponding to the target text content.

9. The method of claim 1, wherein the target data sample comprises at least one of the following:
a text sample, a code sample, a chart sample, or a tool sample.

10. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a first feature representation by sampling from a target feature space, the target feature space being determined by processing a set of training samples with an encoding unit;
processing the first feature representation with a diffusion unit to determine a second feature representation; and
providing the second feature representation to a pre-trained language model to generate a target data sample.

11. The electronic device of claim 10, wherein the encoding unit is trained based on a process comprising:
determining a first training feature representation of a training sample with an encoding unit to be trained;
processing the first training feature representation with the pre-trained language model, to determine a first training loss of a variational autoencoder (VAE) comprising the encoding unit and the pre-trained language model; and
adjusting a parameter of the encoding unit based on the first training loss.

12. The electronic device of claim 10, wherein processing the first feature representation using the diffusion unit to determine the second feature representation comprises:
processing the first feature representation with a noise addition module of the diffusion unit to generate a noise addition feature representation; and
processing the noise addition feature representation with a denoising module of the diffusion unit to generate the second feature representation.

13. The electronic device of claim 10, wherein the diffusion unit is trained based on a process comprising:
determining a second training feature representation by sampling from a training feature space, the training feature space being determined with the trained encoding unit;
processing the second training feature representation with the diffusion unit to determine a second training loss associated with the diffusion unit; and
adjusting a parameter of the diffusion unit based on the second training loss.

14. The electronic device of claim 10, wherein providing the second feature representation to the pre-trained language model to generate the target data sample comprises:
mapping the second feature representation to a target token embedding; and
injecting the target token embedding into the pre-trained language model to generate the target data sample.

15. The electronic device of claim 14, wherein injecting the set of token embeddings to the pre-trained language model comprises one of the following:
injecting the target token embedding as a soft prompt token of the language model to be added before a preset marker token of the language model;
injecting the target token embedding into a key-value cache of the language model; or
injecting the target token embedding into a token embedding space of the language model to be combined with an original token embedding of the language model.

16. The electronic device of claim 10, wherein the target feature space is determined by processing training text content corresponding to the set of training samples with the encoding unit.

17. The electronic device of claim 16, wherein the language model is configured to output target text content based on the second feature representation for generating the target data sample corresponding to the target text content.

18. The electronic device of claim 10, wherein the target data sample comprises at least one of the following:
a text sample, a code sample, a chart sample, or a tool sample.

19. A non-transitory computer-readable storage medium having a computer program stored thereon, the computer program being executable by a processor to implement acts comprising:
obtaining a first feature representation by sampling from a target feature space, the target feature space being determined by processing a set of training samples with an encoding unit;
processing the first feature representation with a diffusion unit to determine a second feature representation; and
providing the second feature representation to a pre-trained language model to generate a target data sample.

20. The non-transitory computer-readable storage medium of claim 19, wherein the encoding unit is trained based on a process comprising:
determining a first training feature representation of a training sample with an encoding unit to be trained;
processing the first training feature representation with the pre-trained language model, to determine a first training loss of a variational autoencoder (VAE) comprising the encoding unit and the pre-trained language model; and
adjusting a parameter of the encoding unit based on the first training loss.
